(19) United States
(12) Patent Application Publication
(10) Pub. No.: US 2021/0295089 A1
(43) Pub. Date: Sep. 23, 2021

(54) NEURAL NETWORK FOR AUTOMATICALLY TAGGING INPUT IMAGE, COMPUTER-IMPLEMENTED METHOD FOR AUTOMATICALLY TAGGING INPUT IMAGE, APPARATUS FOR AUTOMATICALLY TAGGING INPUT IMAGE, AND COMPUTER-PROGRAM PRODUCT

(71) Applicant: BOE ART CLOUD TECHNOLOGY CO., LTD., Changsha, Hunan (CN)

(72) Inventor: Tingting WANG, Beijing (CN)

(21) Appl. No.: 16/626,560

(22) PCT Filed: Jul. 22, 2019
(86) PCT No.: PCT/CN2019/097089

§ 371 Date: Dec. 25, 2019

(30) Foreign Application Priority Data
Jan. 2, 2019 (CN) 201910001380.3

(51) Int. Cl. G06K 9/62; G06N 3/04; G06N 3/08; G06F 16/58

(52) U.S. Cl. CPC G06K 9/628; G06K 9/6232; G06K 9/6277; G06F 16/5866; G06N 3/0454; G06N 3/0472; G06N 3/08; G06K 9/6257

(57) ABSTRACT

A neural network for automatically tagging an input image is provided. The neural network includes a residual attention network configured to extract features of the input image and generate a first feature map including the features of the input image; a first tagging network configured to receive the first feature map and generate a predicted probability of a first tag of the input image; a second tagging network configured to receive the first feature map and generate a predicted probability of a second tag of the input image; and
a third tagging network configured to receive the first feature map and generate a predicted probability of a third tag of the input image.

### CROSS-REFERENCE TO RELATED APPLICATION

This application claims priority to Chinese Patent Application No. 201910001380.3, filed Jan. 2, 2019. Each of the forgoing applications is herein incorporated by reference in its entirety for all purposes.

### TECHNICAL FIELD

The present invention relates to display technology, more particularly, to a neural network for automatically tagging an input image, a computer-implemented method for automatically tagging an input image using a neural network, an apparatus for automatically tagging an input image using a neural network, and a computer-program product.

### BACKGROUND

Deep learning is frequently used in areas including speech recognition, natural language processing, visual recognition. A convolutional neural network has a strong learning ability and is able to efficiently extract and express features, so the convolutional neural network is widely used in deep learning.

### SUMMARY

In one aspect, the present invention provides a neural network for automatically tagging an input image, comprising a residual attention network configured to extract features of the input image and generate a first feature map comprising the features of the input image; a first tagging network configured to receive the first feature map and generate a predicted probability of a first tag of the input image; a second tagging network configured to receive the first feature map and generate a predicted probability of a second tag of the input image; and a third tagging network configured to receive the first feature map and generate a predicted probability of a third tag of the input image.

Optionally, the neural network further comprises a residual net (ResNet) configured to receive the first feature map and generate a second feature map having a scale smaller than a scale of the first feature map.

Optionally, the first tagging network comprises the residual net; a spatial regularization network (SRN) configured to receive the first feature map and generate a first predicted probability of the first tag of the input image; a first sub-network configured to receive the second feature map generated by the residual net and generate a second predicted probability of the first tag of the input image; and the predicted probability of the first tag of the input image is an average value of the first predicted probability and the second predicted probability.

Optionally, the first feature map generated by the residual attention network is inputted, in parallel, into the spatial regularization network of the first tagging network and the residual net, respectively.

Optionally, the first sub-network comprises a first convolutional layer configured to receive the second feature map and generate a third feature map; a first average pooling layer configured to receive the third feature map and generate a fourth feature map; and a first fully connected layer configured to receive the fourth feature map and generate the second predicted probability of the first tag of the input image.

Optionally, the second tagging network comprises the residual net; a first weighting module configured to generate a plurality of first weights respectively corresponding to a plurality of channels of the second feature map and apply a respective one of the plurality of first weights to a respective one of the plurality of channels of the second feature map generated by the residual net, thereby obtaining a fifth feature map; a tagging correlation network comprising a plurality of convolutional sub-layers sequentially connected and configured to apply convolution processes on the fifth feature map, thereby obtaining a sixth feature map; and a second fully connected layer configured to receive the sixth feature map and generate the predicted probability of the second tag of the input image.

Optionally, the third tagging network comprises the residual net; a second weighting module configured to generate a plurality of second weights respectively corresponding to a plurality of channels of the second feature map and apply a respective one of the plurality of second weights to a respective one of the plurality of channels of the second feature map generated by the residual net, thereby obtaining a seventh feature map; a second convolutional layer configured to receive the seventh feature map and generate an eighth feature map; a second average pooling layer configured to receive the eighth feature map and generate a ninth feature map; and a third fully connected layer configured to receive the ninth feature map and generate the predicted probability of the third tag of the input image.

Optionally, the first tagging network comprises the residual net; a spatial regularization network (SRN) configured to receive the first feature map and generate a first predicted probability of the first tag of the input image; and a first sub-network configured to receive the second feature map generated by the residual net and generate a second predicted probability of the first tag of the input image; and the predicted probability of the first tag of the input image is an average value of the first predicted probability and the second predicted probability; the second tagging network comprises the residual net; a first weighting module configured to generate a plurality of first weights respectively corresponding to a plurality of channels of the second feature map and apply a respective one of the plurality of first weights to a respective one of the plurality of channels of the second feature map generated by the residual net to obtain a fifth feature map; a tagging correlation network comprising a plurality of convolutional sub-layers sequentially connected and configured to apply convolution processes on the fifth feature map to obtain a sixth feature map; and a second fully connected layer configured to receive the sixth feature map and generate the predicted probability of the second tag of the input image; and the third tagging network comprises the residual net, a second weighting module configured to generate a plurality of second weights respectively corresponding to a plurality of channels of the second feature map and apply a respective one of the plurality of second weights to a respective one of the plurality of channels of the second feature map generated by the residual net to obtain a seventh feature map; a second convolutional layer configured to receive the seventh feature map and generate an eighth feature map; a second average pooling layer configured to receive the eighth feature map and generate a ninth feature map; and a third fully connected layer configured to receive the ninth feature map and generate the predicted probability of the third tag of the input image; the second feature map generated by the residual net is inputted, in parallel, into the first sub-network of the first tagging network, the first weighting module of the second tagging network, and the second weighting module of the third tagging network, respectively.

Optionally, the residual net comprises a first convolutional sub-layer, a second convolutional sub-layer, a third convolutional sub-layer; the first convolutional sub-layer of the residual net has 512 number of kernels with a kernel size of 1*1; the second convolutional sub-layer of the residual net has 512 number of kernels with a kernel size of 3*3; the third convolutional sub-layer of the residual net has 2048 number of kernels with the kernel size of 1*1; and the first feature map is successively processed by the first convolutional sub-layer of the residual net, the second convolutional sub-layer of the residual net, and the third convolutional sub-layer of the residual net, thereby obtaining the second feature map having a size of 7*7*2048; the first convolutional layer has 2048 number of kernels with the kernel size 3*3 and a stride of 2, configured to generate the third feature map having a size of 3*3*2048; and the first average pooling layer has a first filter with a filter size of 3*3, configured to generate the fourth feature map having a size of 1*1*2048.

Optionally, the residual net comprises a first convolutional sub-layer, a second convolutional sub-layer, and a third convolutional sub-layer; the first convolutional sub-layer of the residual net has 512 number of kernels with a kernel size of 1*1; the second convolutional sub-layer of the residual net has 512 number of kernels with a kernel size of 3*3; the third convolutional sub-layer of the residual net has 2048 number of kernels with the kernel size of 1*1; and the first feature map is successively processed by the first convolutional sub-layer of the residual net, the second convolutional sub-layer of the residual net, and the third convolutional sub-layer of the residual net, thereby obtaining the second feature map having a size of 7*7*2048; the plurality of convolutional sub-layers of the tagging correlation network comprises a convolutional layer having K number of kernels with the kernel size of 1*1, a convolutional layer having 512 number of kernels with a kernel size of 1*1*K, 512 number of kernels with the kernel size of 1*1, and a convolutional layer having 512 groups of kernels, each of 512 groups of kernels has four kernels with a kernel size of 7*7, wherein K represents a total number of a plurality of second tags; the plurality of convolutional sub-layers of the tagging correlation network are sequentially connected; and the fifth feature map is successively processed by the plurality of convolutional sub-layers, thereby generating the sixth feature map.

Optionally, the residual net comprises a first convolutional sub-layer, a second convolutional sub-layer, and a third convolutional sub-layer; the first convolutional sub-layer of the residual net has 512 number of kernels with a kernel size of 1*1; the second convolutional sub-layer of the residual net has 512 number of kernels with a kernel size of 3*3; the third convolutional sub-layer of the residual net has 2048 number of kernels with the kernel size of 1*1; and the first feature map is successively processed by the first convolutional sub-layer of the residual net, the second convolutional sub-layer of the residual net, and the third convolutional sub-layer of the residual net, thereby obtaining the second feature map having a size of 7*7*2048; the second convolutional layer has 2048 number of kernels with the kernel size of 3*3 and a stride of 2; the second average pooling layer has a second filter with a filter size of 3*3, configured to generate the ninth feature map having a size of 1*1*2048; and the third fully connected layer is a Softmax layer.

In another aspect, the present invention provides a computer-implemented method for automatically tagging an input image using a neural network, comprising extracting features of the input image and generating a first feature map comprising the features of the input image using a residual attention network; generating a predicted probability of a first tag of the input image based on the first feature map using a first tagging network; generating a predicted probability of a second tag of the input image based on the first feature map using a second tagging network; and generating a predicted probability of a third tag of the input image based on the first feature map using a third tagging network.

Optionally, the computer-implemented method further comprises setting a first probability threshold for the first tag of the input image and a second probability threshold for the second tag of the input image; wherein the first probability threshold and the second probability threshold are different; the first probability threshold is obtained based on an optimal probability threshold of the first tag of the input image; and the second probability threshold is obtained based on an optimal probability threshold of the second tag of the input image.

Optionally, the computer-implemented method further comprises setting a plurality of probability thresholds for the first tag of the input image; setting a plurality of probability thresholds for the second tag of the input image; obtaining a plurality of correct rates of the first tag respectively using the plurality of probability thresholds for the first tag of the input image; obtaining a plurality of correct rates of the second tag respectively using the plurality of the probability thresholds for the second tag of the input image; setting one of the plurality of probability thresholds for the first tag corresponding to a highest correct rate of the plurality of correct rates of the first tag as the optimal probability threshold of the first tag of the input image; and setting one of the plurality of probability thresholds for the second tag corresponding to a highest correct rate of the plurality of correct rates of the second tag as optimal probability threshold of the second tag of the input image.

Optionally, prior to input the input image into the neural network, the computer-implemented method comprises applying a data augmentation to the input image.

Optionally, the data augmentation comprises a multi-crop method.

Optionally, the computer-implemented method further comprises pretraining the neural network; wherein pretraining the neural network comprises training the residual attention network and the third tagging network using a training database of third tags; adjusting parameters of the residual attention network using a training database of first tags; training the first tagging network using the training database of first tags; training the second tagging network using a training database of second tags; and adjusting parameters of the third tagging network using the training database of third tags.

In another aspect, the present invention provides an apparatus for automatically tagging an input image using a neural network, comprising a memory; one or more processors; wherein the memory and the one or more processors are connected with each other; and the memory stores computer-executable instructions for controlling the one or more processors to extract features of the input image and generate a first feature map comprising the features of the input image using a residual attention network; generate a predicted probability of a first tag of the input image based on the first feature map using a first tagging network; generate a predicted probability of a second tag of the input image based on the first feature map using a second tagging network; and generate a predicted probability of a third tag of the input image based on the first feature map using a third tagging network.

Optionally, the memory stores computer-executable instructions for controlling the one or more processors to pretrain the neural network; wherein pretraining the neural network comprises training the residual attention network and the third tagging network using a training database of third tags; adjusting parameters of the residual attention network using a training database of first tags; training the first tagging network using the training database of first tags; training the second tagging network using a training database of second tags; and adjusting parameters of the third tagging network using the training database of third tags.

In another aspect, the present invention provides a computer-program product comprising a non-transitory tangible computer-readable medium having computer-readable instructions thereon, the computer-readable instructions being executable by a processor to cause the processor to perform extracting features of an input image and generating a first feature map comprising the features of the input image using a residual attention network; generating a predicted probability of a first tag of the input image based on the first feature map using a first tagging network; generating a predicted probability of a second tag of the input image based on the first feature map using a second tagging network; and generating a predicted probability of a third tag of the input image based on the first feature map using a third tagging network.

Optionally, the computer-readable instructions are executable by the processor to cause the processor to perform pretraining a neural network; wherein pretraining the neural network comprises training the residual attention network and the third tagging network using a training database of third tags; adjusting parameters of the residual attention network using a training database of first tags; training the first tagging network using the training database of first tags; training the second tagging network using a training database of second tag; and adjusting parameters of the third tagging network using the training database of third tags.

### BRIEF DESCRIPTION OF THE FIGURES

The following drawings are merely examples for illustrative purposes according to various disclosed embodiments and are not intended to limit the scope of the present invention.

FIG. 1A is a schematic diagram of a structure of a neural network for automatically tagging an input image in some embodiments according to the present disclosure.

FIG. 1B is a schematic diagram of a structure of a neural network for automatically tagging an input image in some embodiments according to the present disclosure.

FIG. 1C is a schematic diagram of a structure of a neural network for automatically tagging an input image in some embodiments according to the present disclosure.

FIG. 2A is a schematic diagram of a structure of a residual attention network in some embodiments according to the present disclosure.

FIG. 2B is a schematic diagram of a structure of a mask branch of a respective one of a plurality of attention modules of a residual attention network in some embodiments according to the present disclosure.

FIG. 2C is a schematic diagram of a structure of a residual net in some embodiments according to the present disclosure.

FIG. 3 is a schematic diagram of a structure of a spatial regularization network in some embodiments according to the present disclosure.

FIG. 4A is a schematic diagram of a structure of the first weighting module in some embodiments according to the present disclosure.

FIG. 4B is a schematic diagram of a structure of the second weighting module in some embodiments according to the present disclosure.

FIG. 5A is a flow chart illustrating a computer-implemented method for automatically tagging an input image using a neural network in some embodiments according to the present disclosure.

FIG. 5B is a flow chart illustrating a method of pre-training the neural network for automatically tagging an input image in some embodiments according to the present disclosure.

FIG. 6 is a schematic diagram of a structure of an apparatus for automatically tagging an input image in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

A convolutional neural network is able to tag an image using a single tag, and the convolutional neural network do a good job in tagging the image with the single tag. However, an image may involve multiple tags, and the convolutional neural network designed to tagging the single tag cannot performed well in tagging multiple tags.

Classifying an image includes a single-tag classification and a multi-tag classification. In the single-tag classification, for example, there are different types of images, such as ink wash painting, oil painting, pencil sketch painting, watercolor painting, etc., an image can only have one of the different types. So, after performing a single-tag classification about the types of an image, the image will have only one tag of the different types. In the multi-tag classification, for example, an image may contain different contents, such as sky, house, mountain, river, house, etc. So, after performing a multi-tag classification about the contents of the image, multiple tags of different contents are assigned to the image, for example, the image may have a tag of house, a tag of sky, and a tag of river at the same time. In the multi-tag classification, it is important to distinguish two tags having similar properties.

Accordingly, the present disclosure provides, inter alia, a neural network for automatically tagging an input image, a computer-implemented method for automatically tagging an input image using a neural network, an apparatus for automatically tagging an input image, and a computer-program product. In one aspect, the present disclosure provides a neural network for automatically tagging an input image. In some embodiments, the neural network includes a residual attention network configured to extract features of the input image and generate a first feature map including the features of the input image; a first tagging network configured to receive the first feature map and generate a predicted probability of a first tag of the input image; a second tagging network configured to receive the first feature map and generate a predicted probability of a second tag of the input image; and a third tagging network configured to receive the first feature map and generate a predicted probability of a third tag of the input image.

Various appropriate tags may be classified in different classifications. Examples of appropriate classifications include, but are not limited to, content tags, theme tags, type tags, tone tags, culture tag, and geographical position tags. Optionally, the first tagging network is a content tagging network, and the first tag is a content tag. Optionally, the second tagging network is a theme tagging network, and the second tag is a theme tag. Optionally, the third tagging network is a type tagging network, and the third tag is a type tag.

As used herein, the term “tagging” refers to a process of assigning keywords to digital data. Different keywords correspond to different tags. For example, an image shows a tree, the tagging process is performed on the image and assigns a “tree” tag to the image.

As used herein, the term “feature map” refers to a map or data representing a particular feature or parameter or characteristic of an image. The feature map may be graphically or mathematically represented. The feature map may be a form of simplified or alternative representation of an image. For example, in some embodiments, the feature map is an outcome of applying a function to a topologically arranged vector of numbers to obtain a vector of corresponding output numbers preserving a topology. For example, a “feature map” is the result of using a layer of convolutional neural network to process an image or another feature map, for example, an image of size (28, 28, 1) is inputted into the convolution layer, and the convolutional layer having 23 number of kernels with a kernel size of 1*1 generates a feature map of size (26, 26, 32) by computing 32 kernels over the input image. A feature map has a width W, a length L, and a depth D, for example, the feature map of size (26, 26, 32) has a width of 26, a length of 26, and a depth of 32. The depth D is also represented by channels of the feature map, so the feature map of size (26, 26, 32) includes 32 channels and each channels has a 26×26 grid of values.

In some embodiments, a convolutional layer has K number of kernels with a kernel size of F*F, a stride of S, and a P number of zero padding added to each column or row of an input image or a feature map. For example, an input image having a width of W1, a height H1, and a depth D1 is inputted in the convolutional layer, the convolutional layer generates an output feature map which has a width W2, a height of H2, and a depth D2 satisfying the following equations:

W2=(W1−F+2P)/S+1 (1)

H2=(H1−F+2P)/S+1 (2);

D2=K (3).

As used herein, the term “predicted probability of a tag of the input image” in the context of the present disclosure refers to a probability of assigning a tag to an input image as predicated by the neural network described herein (e.g., the content tagging network, the theme tagging network, and the type tagging network).

As used herein, the term “content” in the context of the present disclosure (e.g., in the context of the content tagging network) refers to one or more basic materials or one or more elements that are shown by an image, such as a still life, a landscape. For example, a house and a dog is shown in an image, the content of the image includes the house and the dog, and content tags of the image includes a “house” tag and a “dog” tag.

As used herein, the term “theme” in the context of the present disclosure (e.g., in the context of the theme tagging network) refers to an information or an idea expressed or revealed through one or more basic materials, or one or more elements in an image, or any combination thereof. For example, themes of images include, but are not limited to, freedom and social change, heroes and leaders, humans and the environment, identity, immigration and migration, and industry, invention, and progress.

As used herein, the term “type” in the context of the present disclosure (e.g., in the context of the type tagging network) refers to a classification of images based on different techniques used to form the image. For example, images includes images of oil paintings, images of watercolor paintings, images of Gouache paintings, images of pencil sketch, those images of paintings are formed using different painting tools.

As used herein, the term “neural network” refers to a network used for solving artificial intelligence (AI) problems. A neural network includes a plurality of hidden layers. A respective one of the plurality of hidden layers includes a plurality of neurons (e.g. nodes). A plurality of neurons in a respective one of the plurality of hidden layers are connected with a plurality of neurons in an adjacent one of the plurality of hidden layers. Connects between neurons have different weights. The neural network has a structure mimics a structure of a biological neural network. The neural network can solve problems using a non-deterministic manner.

Parameters of the neural network can be tuned by pre-training, for example, a large amount of problems are input in the neural network, and results are obtained from the neural network. Feedbacks on these results is fed back into the neural network to allow the neural network to tune the parameters of the neural network. The pre-training allows the neural network to have a stronger problem-solving ability.

As used herein, the term “convolutional neural network” refers to a deep feed-forward artificial neural network. Optionally, a convolutional neural network includes a plurality of convolutional layers, a plurality of up-sampling layers, and a plurality of down-sampling layers. For example, a respective one of the plurality of convolutional layers can process an image. An up-sampling layer and a down-sampling layer can change a scale of an input image to one corresponding to a certain convolutional layer. The output from the up-sampling layer or the down-sampling layer can then be processed by a convolutional layer of a corresponding scale. This enables the convolutional layer to add or extract a feature having a scale different from that of the input image.

By pre-training, parameters include, but are not limited to, a convolutional kernel, a bias, and a weight of a convolutional layer of a convolutional neural network can be tuned. Accordingly, the convolutional neural network can be used in various applications such as image recognition, image feature extraction, and image feature addition.

As used herein, the term “residual” refers to a difference between an input and an estimation value or a fitting value. An output of a residual network may be acquired by adding an output and an input of convolution cascades and activating a rectified linear unit (ReLU). In this example, a phase of an output of a convolutional layer is identical to a phase of an input of the convolutional layer.

As used herein, the term “convolution” refers to a process of processing an image. A convolutional kernel is used for a convolution. For, each pixel of an input image has a value, a convolutional kernel starts at one pixel of the input image and moves over each pixel in an input image sequentially. At each position of the convolutional kernel, the convolutional kernel overlaps a few pixels on the image based on the size of the convolutional kernel. At a position of the convolutional kernel, a value of one of the few overlapped pixels is multiplied by a respective one value of the convolutional kernel to obtain a multiplied value of one of the few overlapped pixels. subsequently, all multiplied values of the overlapped pixels are added to obtain a sum corresponding to the position of the convolutional kernel on the input image. By moving the convolutional kernel over each pixel of the input image, all the sums corresponding to all the position of the convolutional kernel are collected and output to form an output image. In one example, a convolution may extract different features of the input image using different convolutional kernels. In another example, a convolution process may add more features to the input image using different convolutional kernels.

As used herein, the term “convolutional layer” refers to a layer in a convolutional neural network. The convolutional layer is used to perform convolution on an input image to obtain an output image. Optionally, different convolutional kernels are used to performed different convolutions on the same input image. Optionally, different convolutional kernels are used to performed convolutions on different parts of the same input image. Optionally, different convolutional kernels are used to perform convolutions on different input images, for example, multiple images are inputted in a convolutional layer, a respective convolutional kernel is used to perform a convolution on an image of the multiple images. Optionally, different convolutional kernels are used according to different situations of the input image.

As used herein, the term “convolutional kernel” refers to a two-dimensional matrix used in a convolution process. Optionally, a respective one item of a plurality items in the two-dimensional matrix has a certain value.

As used herein, the term “down-sampling” refers to a process of extracting features of an input image, and outputting an output image with a smaller scale.

As used herein, the term “pooling” refers to a type of down-sampling. Various methods may be used for pooling. Examples of methods suitable for pooling includes, but are not limited to, max-pooling, avg-polling, decimation, and demuxout.

As used herein, the term “up-sampling” refers to a process of adding more information to an input image, and outputting an outputting image with a larger scale.

As used herein, the term “residual attention network” refers to a convolutional neural network using attention mechanism which incorporates with feed-forward network architecture in an end-to-end training fashion (see, e.g., F. Wang, M. Jiang, C. Qian, S. Yang, C. Li, H. Zhang, X. Wang, and X. Tang, Residual attention network for image classification, published at arxiv.org/pdf/1704.06904.pdf on Apr. 23, 2017; the entire contents of which is hereby incorporated by reference).

As used herein, the term “spatial regularization network” refers to a convolutional neural network that exploits both semantic and spatial relations between labels with only image-level supervisions (see, e.g., F. Zhu, H. Li, W. Ouyang, N. Yu, and X. Wang, Learning spatial regularization with image-level supervisions for multi-label image classification, published at arxiv.org/pdf/1702.05891.pdf; the entire contents of which is hereby incorporated by reference).

As used herein, the term “scale” refers to one or any combinations of three dimensions of an image, including one or any combinations of a width of the image, a height of the image, and a depth of the image. In one example, the scale of an image (e.g., a feature map, a data, a signal) refers to a “volume” of an image, which includes the width of the image, the height of the image, and the depth of the image.

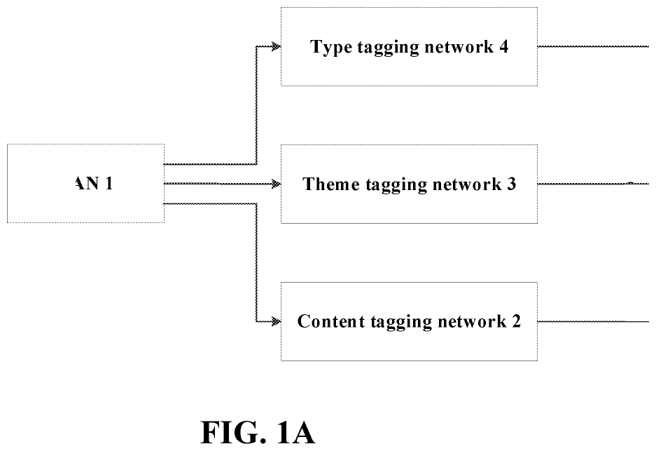

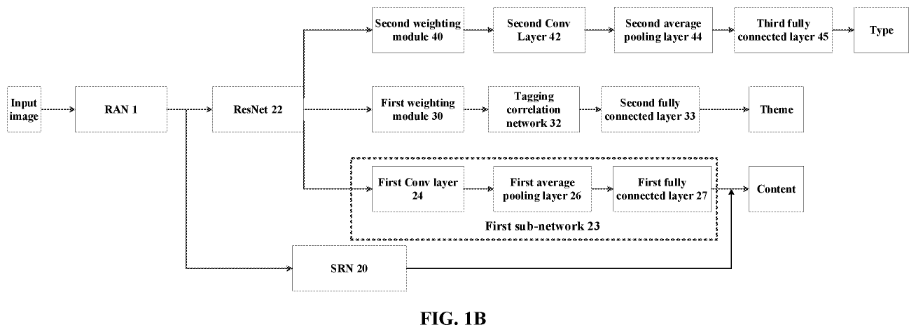

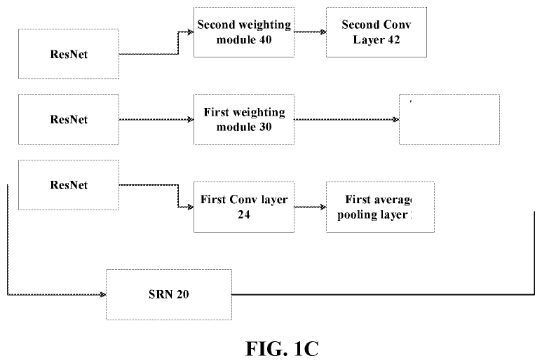

FIG. 1A is a schematic diagram of a structure of a neural network for automatically tagging an input image in some embodiments according to the present disclosure. FIG. 1B is a schematic diagram of a structure of a neural network for automatically tagging an input image in some embodiments according to the present disclosure.

FIG. 1C is a schematic diagram of a structure of a neural network for automatically tagging an input image in some embodiments according to the present disclosure. Referring to FIG. 1A and FIG. 1B, in some embodiments, the neural network for automatically tagging an input image includes a residual attention network (RAN) 1 configured to extract features of the input image and generate a first feature map including the features of the input image; a content tagging network 2 configured to receive the first feature map and generate a predicted probability of a content tag of the input image; a theme tagging network 3 configured to receive the first feature map and generate a predicted probability of a theme tag of the input image; and a type tagging network 4 configured to receive the first feature map and generate a predicted probability of a type tag of the input image.

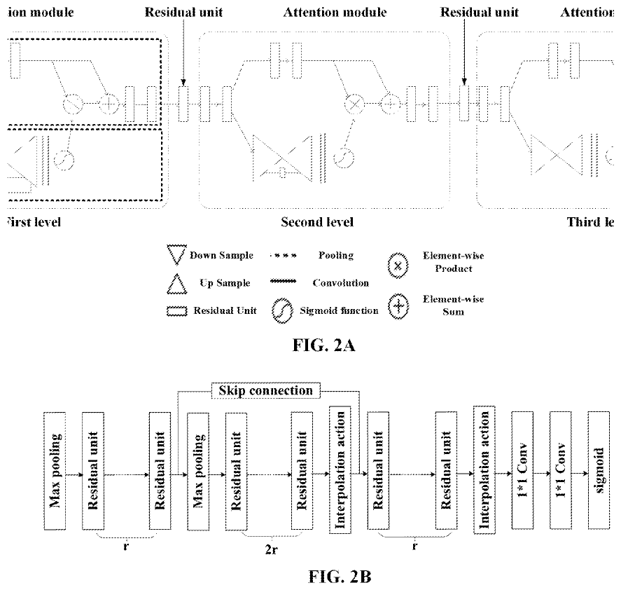

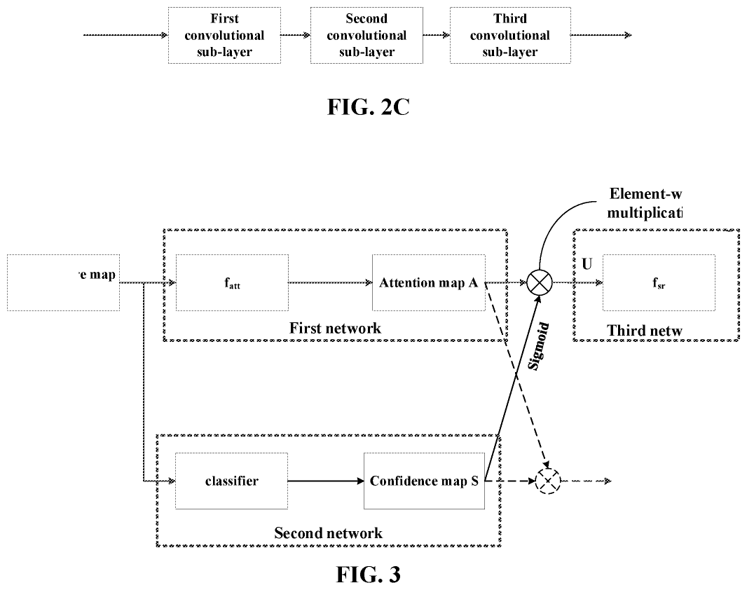

FIG. 2A is a schematic diagram of a structure of a residual attention network in some embodiments according to the present disclosure. FIG. 2B is a schematic diagram of a structure of a mask branch of a respective one of a plurality of attention modules of a residual attention network in some embodiments according to the present disclosure. In some embodiments, referring to FIG. 2A and FIG. 2B, the residual attention network (RAN) 1 includes a plurality of attention modules and a plurality of residual units. Optionally, the plurality of attention modules and the plurality of residual units are alternatively arranged. Optionally, the residual attention network (RAN) 1 includes three levels of attention modules, and different attention modules are configured to capture different types of attention.

In some embodiments, a respective one of the plurality of attention modules includes a trunk branch configured to extract features and a mask branch configured to learn same size mask that weights output features extracted by the trunk branch. Optionally, the trunk branch includes a plurality of residual units. Examples of residual units suitable to be used in the trunk branch include, but are not limited to, a pre-activation residual unit, a ResNeXt unit, an Inception unit. Optionally, the mask branch includes a bottom-up top-down structure. For example, the bottom-up top-down structure is configured to perform a fast feed-forward sweep step and a top-down feedback step. The first feed-forward sweep step is configured to collect global information of the input image. Optionally, the mask branch generates attention regions corresponding to each pixel of the feature map, by combining the attention regions from the mask branch and the feature map from the trunk branch, so that the good features of the feature map is enhanced, and the noises in the feature map is suppressed.

Referring to FIG. 2B, r represents number of residual units between adjacent pooling layers in the mask branch. For example, max pooling are performed to increase a receptive field. Subsequent to reaching the lowest resolution, the global information is expended by a symmetrical top-down architecture to guide input features in each position. Interpolation actions up sample the output after multiple residual units. The number of interpolation actions is the same as a max pooling for keeping an output feature map having an output size the same as a size of the input feature map. A sigmoid layer normalizes the output range of the output feature map. Optionally, a skip connection (e.g., a residual unit) is added between bottom-up and top-down parts to capture information from different scales.

In some embodiments, referring to FIG. 1A, FIG. 2A, FIG. 2B, according to the equations (1), (2), (3), an input image having a size of 224*224*3 is input in the residual attention network (RAN) 1, the first feature map outputted from the residual attention network (RAN) 1 has a size of 14*14*1024.

In some embodiments, referring to FIG. 1A and FIG. 1B, the content tagging network 2 is subsequently connected to the residual attention network (RAN) 1 and receives the first feature map outputted from the residual attention network (RAN) 1. Optionally, the content tagging network includes a residual net (ResNet) 22 configured to receive the first feature map and generate a second feature map having a scale smaller than a scale of the first feature map; a spatial regularization network (SRN) 20 configured to receive the first feature map and generate a first predicted probability of the content tag of the input image; and a first sub-network 23 configured to receive the second feature map generated by the residual net (ResNet) 22 and generate a second predicted probability of the content tag of the input image. Optionally, the predicted probability of the content tag of the input image is an average value of the first predicted probability and the second predicted probability. For example, a scale of a feature map represents a spatial dimension of a feature map (e.g., Width*Length of a feature map).

Optionally, the first feature map having the size of 14*14*1024 generated by the residual attention network (RAN) 1 is inputted, in parallel, into the spatial regularization network (SRN) 20 and the residual net (ResNet) 22, respectively.

In some embodiments, the spatial regularization network (SRN) 20 is configured to be used in a process of multi-tagging the input image. Optionally, the spatial regularization network (SRN) 20 is configured to tag content tags on the input image, for example, the spatial regularization network (SRN) 20 is configured to tag content tags on the input image of a drawing.

It is a complicated process to tag content tags on the input image, because there are semantic relations between different content tags, and there are spatial relations between different content tags. In some embodiments, the first feature map is generated by extracting features of the input image using attention mechanism in the residual attention network (RAN) 1, but the residual attention network (RAN) 1 haven't dealt with the relations (e.g., the semantic relations and the spatial relations) between different content tags. So, the spatial regularization network (SRN) 20 is configured to obtain relations between different content tags, including the semantic relations and spatial relations.

As used herein, the term “semantic relation” refers to an association that exists between the meaning of two elements, for example, an association that exits between meaning of two content tags. As used herein, the term “spatial relation” refers to an association described by means of one-, two- or three-dimensional coordinate system, for example, an association between positions of two content tags in an input image.

FIG. 3 is a schematic diagram of a structure of a spatial regularization network in some embodiments according to the present disclosure. Referring to FIG. 3, in some embodiments, the spatial regularization network (SRN) 20 has a first network, a second network, and a third network. Optionally, the first network and the second network are configured to generate weighted attention map U, and the third network is configured to generate the first predicted probability of the content tag of a plurality of content tags (e.g. a first predicted probability of a respective one of a plurality of types of contents). The first predicted probability of the content tag refers to a predicted probability of assigning the tag to the input image.

Optionally, the first network includes an attention estimator fₐₜ configured to receive first feature map X having the size of 14*14*1024 and generate an attention map A. For example, the attention estimator fₐₜₜ includes a convolutional layer has 512 number of kernels with the kernel size of 1*1, a convolutional layer has 512 number of kernels with the kernel size of 3*3, and a convolutional layer has C number of kernels with the kernel size of 1*1 (C is a total number of the plurality of content tags, e.g. a total number of types of contents). So, subsequent to inputting the first feature map X having the size of 14*14*1024 into the attention estimator fₐₜₜ, the attention map A having a size of 14*14*C is generated by the attention estimator fₐₜₜ.

Optionally, the second network includes a classifier configured to estimate a confidence of the respective one of the plurality of content tags. For example, the classifier is a convolutional layer having C number of kernels with the kernel size of 1*1, the first feature map X is inputted into the classifier (e.g., the convolutional layer) of the second network, and the second network generates a confidence map S including confidences of the plurality of content tags estimated by the classifier. The attention map A could be used to weightedly average the features in the first feature maps X to generate a weightedly-average visual feature vector which is used to learn the classifier for estimating the confidence of the respective one of the plurality of content tags.

Optionally, subsequent to obtaining the attention map A and the confidence map S, the confidence map S is converted using a sigmoid function and obtained a normalized confidence map. The normalized confidence map and the attention map A are element-wisely multiplied to obtain a weighted attention map U. The weighted attention map U is inputted in the third network, subsequently, the third network generates the first predicted probability of the content tag. Optionally, the third network includes a confidence estimator fₛᵣ. Optionally, the confidence estimator fₛᵣ includes a convolutional layer having 512 number of kernels with a kernel size of 1*1*C, a convolutional layer having 512 number of kernels with a kernel size of 1*1*512, and a convolutional layer having 2048 number of kernels with a kernel size of 14*14*1. For example, the first two convolutional layers of the confidence estimator fₛᵣ extract semantic relations, and the last convolutional layer of the confidence estimator fₛᵣ extracts spatial relations. The last convolutional layer of the confidence estimator fₛᵣ has 512 group of kernels, which means every 4 kernels convolve with the same feature channel of a feature map inputted in the last convolutional layer of the confidence estimator fₛᵣ.

In some embodiments, referring to FIG. 1B, the first sub-network includes the residual net (ResNet) 22, and the first sub-network 23. Optionally, the first sub-network 23 includes a first convolutional layer 24 configured to receive the second feature map and generate a third feature map, a first average pooling layer 26 configured to receive the third feature map and generate a fourth feature map, and a first fully connected layer 27 configured to receive the fourth feature map and generate the second predicted probability of the content tag of the input image. Optionally, the first sub-network 23 includes the first average pooling layer 26 and the first fully connected layer 27, and the first average pooling layer 26 is directly connected to the residual net (ResNet) 22 and receives the second feature map outputted from the residual net (ResNet) 22. Optionally, the residual net (ResNet) 22 can be included in the first sub-network 23. For example, the first sub-network 23 includes the residual net (ResNet) 22, the first convolutional layer 24, the first average pooling layer 26, and the first fully connected layer 27.

FIG. 2C is a schematic diagram of a structure of a residual net in some embodiments according to the present disclosure. In some embodiments, referring to FIG. 2C, the residual net (ResNet) 22 is configured to receive the first feature map and generate the second feature map having a scale smaller than a scale of the first feature map. Optionally, the residual net (ResNet) 22 includes a first convolutional sub-layer, a second convolutional sub-layer, and a third convolutional sub-layer. Optionally, the first convolutional sub-layer of the residual net (ResNet) 22 has 512 number of kernels with the kernel size of 1*1; the second convolutional sub-layer of the residual net (ResNet) 22 has 512 number of kernels with the kernel size of 3*3; and the third convolutional sub-layer of the residual net (ResNet) 22 has 2048 number of kernels with the kernel size of 1*1.

For example, the first feature map having the size of 14*14*1024 is successively processed by the first convolutional sub-layer of the residual net (ResNet) 22, the second convolutional sub-layer of the residual net (ResNet) 22, and the third convolutional sub-layer of the residual net (ResNet) 22, thereby obtaining the second feature map having a size of 7*7*2048 which has a smaller scale than the scale of the first feature map having the size of 14*14*1024.

Optionally, when the first sub-network 23 includes the first average pooling layer 26 directly connected to the residual net (ResNet) 22, and the first fully connected layer 27 connected to the first average pooling layer 26. The second feature map having a size of 7*7*2048 is directly inputted into the first average pooling layer 26. Optionally, the first average pooling layer 26 has a filter with a filter size of 7*7 which may generate a feature map have a size of 1*1*2048 after the second feature map is directly inputted into the first average pooling layer 26.

Optionally, the first sub-network 23 includes the first convolutional layer 24, the first average pooling layer 26, and the first fully connected layer 27, sequentially connected to the residual net (ResNet) 22. For example, the first convolutional layer 24 directly receives the second feature map from the residual net (ResNet) 22. Optionally, the first convolutional layer 24 of the first sub-network 23 has 2048 number of kernels with the kernel size of 3*3 and a stride of 2. For example, the first convolutional layer 24 of the first sub-network 23 receives the second feature map having the size of 7*7*2048, and generates the third feature map having a size of 3*3*2048. Optionally, the first average pooling layer 26 has a first filter with a filter size of 3*3, configured to generate the fourth feature map having a size of 1*1*2048. For example, the first average pooling layer 26 receives the third feature map having the size of 3*3*2048, and generates the fourth feature map having the size of 1*1*2048.

In some embodiments, the first fully connected layer 27 receives the fourth feature map having the size of 1*1*2048 and predicts probability of the content tag based on the fourth feature map to generate the second predicted probability of the content tag.

In some embodiments, tagging content tags to the input image is a process of assigning multiple tags to the input image. After the fourth feature map is generated, the fourth feature map is inputted into the first fully connected layer 27, and the first fully connected layer 27 has a plurality of nodes, each node is a binary classifier. For example, the first fully connected layer 27 has 2048 nodes, and each of the 2048 nodes is a binary classifier.

A loss function used in the first sub-network 23 is as follows:

L=Σₗ₌₁^{C}y^{l} log ŷ^{l}+(1−ŷ^{l})log(1−ŷ^{l})

C represents the total number of the plurality of content tags, e.g. the total number of types of contents; y^{l} represents a ground truth of an l-th content tag of the plurality of content tags; ŷ^{l} represents a second predicted probability of the l-th content tag of the plurality of content tags.

In some embodiments, the predicted probability of the content tag of the input image is obtained based on the first predicted probability of the content tag from the spatial regularization network (SRN) 20 and the second predicted probability of the content tag from the first fully connected layer 27. Optionally, the predicted probability of the content tag is an average value of the first predicted probability of the content tag and the second predicted probability of the content tag.

In some embodiments, by using the residual attention network (RAN) 1 and the content tagging network including the spatial regularization network (SRN) 20, the residual net (ResNet) 22, and the first sub-network 23, the present disclosure can adopt attention mechanism and extract relations (e.g., the semantic relations and the spatial relations) between different content tags.

Referring to FIG. 1B, in some embodiments, the theme tagging network 3 includes a residual net (ResNet) 22, a first weighting module 30, a tagging correlation network 32, and a second fully connected layer 33. Tagging theme tags to the input image is also a process of assigning multiple tags to the input image. Because different portions of the input image may contain different contents, tagging content tags should consider different portions of the input image, so, attention mechanism should be adopted during the process of tagging the content tags. Tagging theme tags only needs to consider the whole picture of the input image, so, attention mechanism is not necessary in the theme tagging network 3. The theme tagging network 3 only extracts relations (e.g., the semantic relations and the spatial relations) between different theme tags.

In one example, referring to FIG. 1B, the residual net of the theme tagging network 3 is the same residual network of the content tagging network 2. For example, the theme tagging network 3 and the content tagging network 2 share a same residual net (ResNet) 22. In another example, referring to FIG. 1C, the residual net of the theme tagging network 3 and the residual net of the content tagging network are different networks.

In some embodiments, referring to FIG. 1B, the theme tagging network 3 includes the residual net (ResNet) 22 configured to receive the first feature map having the size of 14*14*1024 from the residual attention network (RAN) 1. The residual net (ResNet) 22 of the theme tagging network 3 generates the second feature map having the size of 7*7*2048. For example, the residual net (ResNet) 22 of the theme tagging network 3 includes the first convolutional sub-layer, the second convolutional sub-layer, and the third convolutional sub-layer. The first convolutional sub-layer of the residual net of the theme tagging network 3 has 512 number of kernels with the kernel size of 1*1. The second convolutional sub-layer of the residual net of the theme tagging network 3 has 512 number of kernels with the kernel size of 3*3. The third convolutional sub-layer of the residual net of the theme tagging network 3 has 2048 number of kernels with the kernel size of 1*1. The first feature map having the size of 14*14*1024 is successively processed by the first convolutional sub-layer of the residual net, the second convolutional sub-layer of the residual net, and the third convolutional sub-layer of the residual net to obtain the second feature map having the size of 7*7*2048.

In some embodiments, the first weighting module 30 is configured to generate a plurality of first weights respectively corresponding to a plurality of channels of the second feature map and apply a respective one of the plurality of first weights to a respective one of the plurality of channels of the second feature map generated by the residual net (ResNet) 22, to obtain a fifth feature map. Optionally, the first weighting module 30 is a SE (Squeeze-and-excitation) unit.

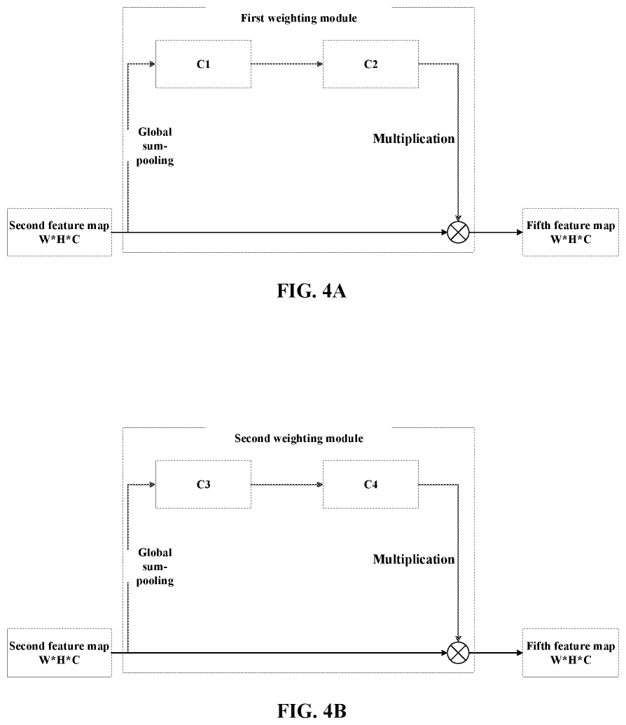

FIG. 4A is a schematic diagram of a structure of the first weighting module in some embodiments according to the present disclosure. Referring to FIG. 4A, in some embodiments, the second feature map having the size of 7*7*2048 from the residual net (ResNet) 22 is inputted into the first weight module 30. W*H*C represents the size of a feature map, W represents a width of the feature map, H represent a height of the feature map, and C represents a total number of channels of the feature map, W*H represents a spatial dimension of the feature map, for example, the second feature map has the size of 7*7*2048, so, W is 7, H is 7, and C is 2048.

In some embodiments, an SEunit performs a squeeze operation, an excitation operation, and a reweight operation. Optionally, a global sum-pooling is used to perform the squeeze operation. The global sum-pooling process is performed on the second feature map to generate a C-dimensional vector (e.g., a feature map having C number of channels). For example, subsequent to inputting the second feature map having the size of 7*7*2048 to the SE unit, the global sum-pooling process generates a first intermediate feature map having 2048 channels (e.g., a 2048-dimensional vector). Optionally, examples of appropriate pooling method used to perform the squeeze operation include, but are not limited to global average-pooling, global max-pooling, sum-pooling, average-pooling, and max-pooling.

Optionally, the SE unit includes a C1 layer having Relu function and a C2 layer having Sigmoid function. The excitation operation includes using the C1 layer and the C2 layer to generate the plurality of first weights respectively corresponding to the plurality of channels of the second feature map (which is equivalent to a plurality of channels of the first intermediate feature map). The parameters of the C1 layer and the C2 layer is trained by learning correlations between different channels of a feature map.

Optionally, in the reweight operation, a respective one of the plurality of first weights are considered as an importance of a respective one of the plurality of channels of the second feature map (which is equivalent to the plurality of channels of the first intermediate feature map). The reweight operation includes applying the respective one of the plurality of first weights to the respective one of the plurality of channels of the second feature map (which equivalent to the plurality of channels of the first intermediate feature map) using multiplication, e.g., element-wise multiplication. The reweight operation is configured to reweight weights of features in the feature maps.

Optionally, the SE unit can be connected to any convolutional layer to distinguish different impacts of the different channels on a feature map. A function of the SE unit is similar to a function of the residual attention net (RAN), the SE unit and the residual attention network (RAN) use different methods to achieve similar functions. For example, the SE unit obtains or learns the importance of the respective one of the plurality of channels of the second feature map (which is equivalent to the plurality of channels of the first intermediate feature map) based on the different importance of different channels. Using the different importance of different channels, the good feature of the feature map is enhanced, and the noises in the feature map is suppressed. For example, by inputting the second feature map having the size of 7*7*2048 into the SE unit, the SE unit generates the fifth feature map having a size of 7*7*2048.

Multi-tag classification is more complicated than single-tag classification. In multi-tag classification, the tags not only has correlations with different portions of the input image, the tags also has correlations between each other. For example, a “sky” tag is usually in a top portion of the input image, a “grass” tag is usually in a bottom portion of the input image. Also, the “sky” tag and a “cloud” tag usually has relatively high correlation, the “sky” tag and the “cloud” tag usually appear together.

Multi-tag classification is different from tag identification. In tag identification, classifications of tags and positions of tags are provided, in multi-tag classification, the positions of tags are not provided.

In some embodiments, referring to FIG. 1B, the theme tagging network 3 includes the tagging correlation network 32. Optionally, the fifth feature map generated by the first weighting module 30 is inputted into the tagging correlation network 32. Optionally, the tagging correlation network 32 is a label relation net which adopts a thought of the spatial regularization network (SRN) 20, but only deals with relations between different tags.

Optionally, the tagging correlation network 32 includes a plurality of convolutional sub-layers sequentially connected and configured to apply convolution processes on the fifth feature map, thereby obtaining a sixth feature map. Optionally, the plurality of convolutional sub-layers of the tagging correlation network 32 includes a convolutional layer having K number of kernels with the kernel size of 1*1*2048, a convolutional layer having 512 number of kernels with a kernel size of 1*1*K, 512 number of kernels with the kernel size of 1*1*512, and a convolutional layer having 512 groups of kernels, each of 512 groups of kernels has four kernels with a kernel size of 7*7*1, wherein K represents a total number of the plurality of theme tags, e.g. a total number of types of themes. Optionally, the plurality of convolutional sub-layers in the tagging correlation network are sequentially connected. For example, the fifth feature map having the size of 7*7*2048 is successively processed by the plurality of convolutional sub-layers to generate the sixth feature map having a size of 1*1*2048.

In some embodiments, the theme tagging network 3 includes the second fully connected layer 33 configured to receive the sixth feature map and generate the predicted probability of the theme tag of the input image. For example, the predicted probability of the theme tag of the input image is the probability of assigning the theme tag to the input image.

In some embodiments, tagging theme tags to the input image is a process of assigning multiple tags to the input image. After the sixth feature map is generated, the sixth feature map is inputted into the second fully connected layer 33, and the second fully connected layer 33 has a plurality of nodes, each node is a binary classifier. For example, the second fully connected layer 33 has 2048 nodes, and each of the 2048 nodes is a binary classifier.

A loss function used in the theme tagging network 3 is as follows:

L=−Σₗ₌₁^{K}x^{l} log \hat{x}^{l}(1−x^{l})log(1−\hat{x}^{l})

K represents the total number of the plurality of theme tags, e.g. the total number of types of themes; x^{l} represents a ground truth of an l-th theme tag of the plurality of theme tags; \hat{x}^{l} represents a predicted probability of the l-th theme tag of the plurality of theme tags.

Referring to FIG. 1B, in some embodiments, the type tagging network 4 includes a residual net, a second weighting module 40, a second convolutional layer 42, and a second average pooling layer 44.

In one example, referring to FIG. 1B, the residual net of the type tagging network 4 is the same residual net of the content tagging network 2 and the same residual net of the theme tagging network 3. For example, the content tagging network 2, the theme tagging network 3, and the type tagging network 4 shares the same residual net (ResNet) 22. In another example, referring to FIG. 1C, the residual net of the theme tagging network 3 is different from the residual net of the content tagging network 2, and the residual net of the theme tagging network 3.

In some embodiments, referring to FIG. 1B, the type tagging network 4 includes the residual net (ResNet) 22 configured to receive the first feature map having the size of 14*14*1024 from the residual attention network (RAN) 1. The residual net (ResNet) 22 of the type tagging network 4 generates the second feature map having the size of 7*7*2048. For example, the residual net (ResNet) 22 of the type tagging network 4 includes the first convolutional sub-layer, the second convolutional sub-layer, and the third convolutional sub-layer. The first convolutional sub-layer of the residual net of the type tagging network 4 has 512 number of kernels with the kernel size of 1*1. The second convolutional sub-layer of the residual net of the type tagging network 4 has 512 number of kernels with the kernel size of 3*3. The third convolutional sub-layer of the residual net of the type tagging network 4 has 2048 number of kernels with the kernel size of 1*1. The first feature map having the size of 14*14*1024 is successively processed by the first convolutional sub-layer of the residual net, the second convolutional sub-layer of the residual net, and the third convolutional sub-layer of the residual net to obtain the second feature map having the size of 7*7*2048.

In some embodiments, the second weighting module 40 is configured to generate a plurality of second weights respectively corresponding to the plurality of channels of the second feature map and apply a respective one of the plurality of second weights to the respective one of the plurality of channels of the second feature map generated by the residual net (ResNet) 22, thereby obtaining a seventh feature map. Optionally, the second weighting module 40 is a SE (Squeeze-and-excitation) unit.

FIG. 4B is a schematic diagram of a structure of the second weighting module in some embodiments according to the present disclosure. Referring to FIG. 4B, in some embodiments, the second feature map having the size of 7*7*2048 from the residual net (ResNet) 22 is inputted into the second weight module 40. For example, the second feature map has the size of 7*7*2048, so, W is 7, H is 7, and C is 2048.

In some embodiments, an SE unit performs a squeeze operation, an excitation operation, and a reweight operation. Optionally, a global sum-pooling is used to perform the squeeze operation, the global sum-pooling process is performed on the second feature map to generate a T-dimensional vector (e.g., a feature map having T number of channels). For example, subsequent to inputting the second feature map having the size of 7*7*2048 to the SE unit, the global sum-pooling process generates a second intermediate feature map having 2048 channels (e.g., a 2048-dimensional vector). Optionally, examples of appropriate pooling method used to perform the squeeze operation include, but are not limited to global average-pooling, global max-pooling, sum-pooling, average-pooling, and max-pooling.

Optionally, the SE unit includes a C3 layer having Relu function and a C4 layer having Sigmoid function. The excitation operation includes using the C3 layer and the C4 layer to generate the plurality of second weights respectively corresponding to the plurality of channels of the second feature map (which is equivalent to a plurality of channels of the second intermediate feature map). The parameters of the C3 layer and the C4 layer is trained by learning correlations between different channels of the feature map.

Optionally, in the reweight operation, a respective one of the plurality of second weights are considered as an importance of a respective one of the plurality of channels of the second feature map (which is equivalent to the plurality of channels of the second intermediate feature map). The reweight operation includes applying the respective one of the plurality of second weights to the respective one of the plurality of channels of the second feature map (which is equivalent to the plurality of channels of the second intermediate feature map) using multiplication, e.g., element-wise multiplication. The reweight operation is configured to reweight weights of features in the feature maps. For example, Optionally, by inputting the second feature map having the size of 7*7*2048 into the SE unit, the SE unit generates the seventh feature map having a size of 7*7*2048.

In some embodiments, referring to FIG. 1B, the second convolutional layer 42 is configured to receive the seventh feature map and generate an eighth feature map. Optionally, the second convolutional layer 42 has 2048 number of kernels with the kernel size of 3*3 and a stride of 2. For example, the seventh feature map having the size of 7*7*2048 is inputted into the second convolutional layer 42, and the second convolutional layer 42 generates the eighth feature map having a size of 3*3*2048.

In some embodiments, the second average pooling layer 44 is configured to receive the eighth feature map and generate a ninth feature map. Optionally, the second average pooling layer 4 has a second filter with a filter size of 3*3 and is configured to generate the ninth feature map having a size of 1*1*2048. For example, eighth feature map having the size of 3*3*2048 is inputted in the second average pooling layer 44, and the second average pooling layer 44 generates the ninth feature map has a size of 1*1*2048.

In some embodiments, the third fully connected layer 45 is configured to receive the ninth feature map and generate the predicted probability of the type tag of the input image. Optionally, the third fully connected layer is a Softmax layer. As used herein, the term “Softmax layer” refers to a layer that performs a logistic regression function which calculates the probability of the input belonging to every one of the existing classes. For example, the Softmax layer limits the scope of its calculations to a specific set of classes and output a result in a specific range, e.g., a range from 1 to 0, for each one of the classes.

In some embodiments, the neural network disclosed herein can tag the content tag, the theme tag, and the type tag to the input image. Optionally, the neural network can tag the content tag, the theme tag, and the type tag to the input image at the same time.

For example, referring to FIG. 1A and FIG. 1B, the neural network includes the residual attention network (RAN) 1, the content tagging network 2, the theme tagging network 3, and the type tagging network 4.

The content tagging network 2 includes the residual net (ResNet) 22; the spatial regularization network (SRN) 20 configured to receive the first feature map and generate the first predicted probability of the content tag of the input image; and the first sub-network 23 configured to receive the second feature map generated by the residual net (ResNet) 22 and generate the second predicted probability of the content tag of the input image. The predicted probability of the content tag of the input image is an average value of the first predicted probability and the second predicted probability.

The theme tagging network 3 includes the residual net (ResNet) 22; the first weighting module 30 configured to generate the plurality of first weights respectively corresponding to the plurality of channels of the second feature map and apply the respective one of the plurality of first weights to the respective one of the plurality of channels of the second feature map generated by the residual net (ResNet) 22 to obtain the fifth feature map; the tagging correlation network 32 including the plurality of convolutional sub-layers sequentially connected and configured to apply convolution processes on the fifth feature map to obtain the sixth feature map; and the second fully connected layer 33 configured to receive the sixth feature map and generate the predicted probability of the theme tag of the input image.

The type tagging network includes the residual net (ResNet) 22, the second weighting module 40 configured to generate the plurality of second weights respectively corresponding to the plurality of channels of the second feature map and apply the respective one of the plurality of second weights to the respective one of the plurality of channels of the second feature map generated by the residual net (ResNet) 22 to obtain the seventh feature map; the second convolutional layer 42 configured to receive the seventh feature map and generate the eighth feature map; the second average pooling layer 44 configured to receive the eighth feature map and generate the ninth feature map; and the third fully connected layer 45 configured to receive the ninth feature map and generate the predicted probability of the type tag of the input image.

Optionally, the second feature map generated by the residual net (ResNet) 22 is inputted, in parallel, into the first sub-network 23 of the content tagging network 2, the first weighting module 30 of the theme tagging network 3, and the second weighting module 40 of the type tagging network 4, respectively.

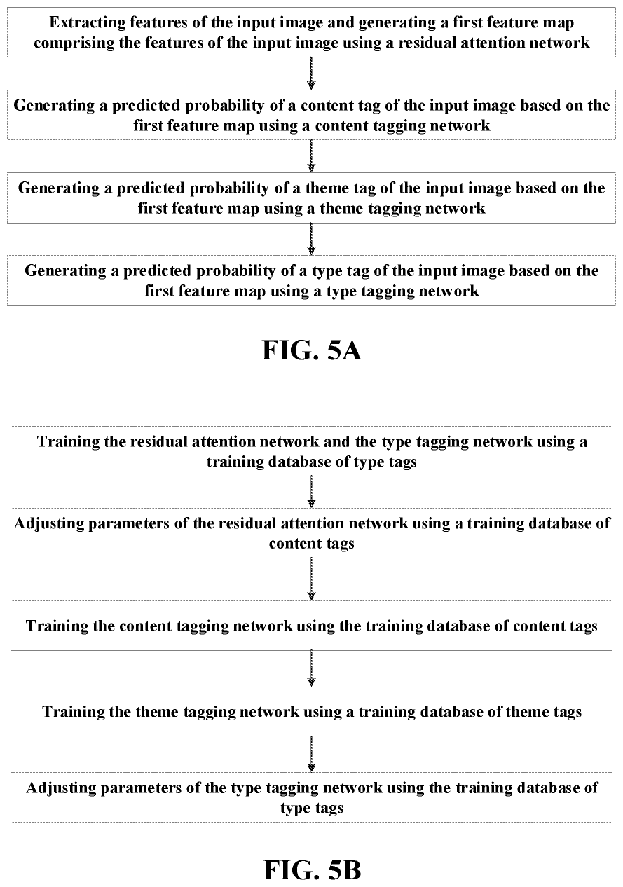

In another aspect, the present disclosure also provides a computer-implemented method for automatically tagging an input image using a neural network. FIG. 5A is a flow chart illustrating a computer-implemented method for automatically tagging an input image using a neural network in some embodiments according to the present disclosure. Referring to FIG. 5A, in some embodiments, a computer-implemented method for automatically tagging an input image using a neural network includes extracting features of the input image and generating a first feature map including the features of the input image using a residual attention network; generating a predicted probability of a first tag of the input image based on the first feature map using a first tagging network; generating a predicted probability of a second tag of the input image based on the first feature map using a second tagging network; and generating a predicted probability of a third tag of the input image based on the first feature map using a third tagging network.

Various appropriate tags may be classified in different classifications. Examples of appropriate classifications include, but are not limited to, content tags, theme tags, type tags, tone tags, culture tags, and geographical position tags. Optionally, the first tagging network is a content tagging network, and the first tag is a content tag. Optionally, the second tagging network is a theme tagging network, and the second tag is a theme tag. Optionally, the third tagging network is a type tagging network, and the third tag is a type tag.

In some embodiments, the computer-implemented method for automatically tagging the input image using a neural network includes pretraining the neural network using a method described herein; inputting the input image into the neural network; generating the predicted probability of the content tag of the input image; generating the predicted probability of the theme tag of the input image; and generating the predicted probability of type tag of the input image.

In some embodiments, for the multiple tagging classification such as tagging the content tag of the input image and tagging the theme tag of the input image, the computer-implemented method further includes setting a first probability threshold for the content tag of the input image and a second probability threshold for the theme content tag of the input image. Optionally, the first probability threshold and the second probability threshold are different. Optionally, the first probability threshold is obtained based on an optimal probability threshold of the content tag of the input image. Optionally, the second probability threshold is obtained based on an optimal probability threshold of the theme tag of the input image.

In one example, when the predicted probability of the content tag is greater than the optimal probability threshold of the content tag of the input image, the content tag is tagged on the input image. In another example, when the predicted probability of the theme tag is greater than the optimal probability threshold of the theme tag of the input image, the theme tag is tagged on the input image.

In some embodiments, obtaining the first probability threshold includes setting a plurality of probability thresholds for the content tag of the input image; obtaining a plurality of correct rates of the content tag respectively using the plurality of probability thresholds for the content tag of the input image; and setting one of the plurality of probability thresholds for the content tag corresponding to a highest correct rate of the plurality of correct rates of the content tag as the optimal probability threshold of the content tag of the input image.

For example, the plurality of probability thresholds of the content tag of the input image are in a range of 0 to 1, e.g., P1, P2, . . . , P9 are in the range of 0 to 1. A training database of content tags are used to train the neural network to obtain a probability of the content tag. the plurality of correct rates (e.g., K1, K2, . . . , K9) are respectively calculated under the plurality of probability thresholds of the content tag, the probability threshold corresponding to the highest correct rate is set as the optimal probability threshold of the content tag of the input image.

In some embodiments, obtaining the second probability threshold includes setting a plurality of probability thresholds for the theme tag of the input image; obtaining a plurality of correct rates of the theme tag respectively using the plurality of the probability thresholds for the theme tag of the input image; and setting one of the plurality of probability thresholds for the theme tag corresponding to a highest correct rate of the plurality of correct rates of the theme tag as the optimal probability threshold of the theme tag of the input image.

In some embodiments, for the single tagging classification such as tagging the type tag of the input image, the type tag to be tagged on the input image is the type tag having a highest predicted probability.

In some embodiments, prior to input the input image into the neural network, the computer-implemented method includes applying a data augmentation to the input image. Optionally, the data augmentation includes a multi-crop method.

The data augmentation is used for increase sample diversity. For example, the data augmentation is used on slanted photos or dim photos to increase the number of samples of the slanted photos or the dim photos. Various appropriate methods may be used in the data augmentation. Examples of methods suitable for using in the data augmentation include, but are not limited to flip, random crop, color jittering, shift, scale, contrast, noise, rotation, and reflection. For example, it is necessary to distinguish different types of images, such as distinguish an image showing oiling painting and an image showing watercolor painting, by detecting the details of different types of images, so the data augmentation can use multi-crop to zoon in details.

FIG. 5B is a flow chart illustrating a method of pre-training the neural network for automatically tagging an input image in some embodiments according to the present disclosure. Referring to FIG. 5B, in some embodiments, the computer-implemented method further includes pertaining the neural network. Optionally, pretraining the neural network includes training the residual attention network and the type tagging network using a training database of type tags; adjusting parameters of the residual attention network using a training database of content tags; training the content tagging network using the training database of content tags; training the theme tagging network using a training database of theme tags; adjusting parameters of the type tagging network using the training database of type tags.

Optionally, while adjusting parameters of the residual attention network using the training database of content tags, parameters of the type tagging network are kept the same. Optionally, while training the content tagging network using the training database of content tags, parameters of the type tagging network are kept the same. Optionally, while training the theme tagging network using the training database of theme tags, parameters of the residual attention network, parameters of content tagging network, and parameters of type tagging network are kept the same.

In some embodiments, the training method provided by the present disclosure includes training the residual attention network and the type tagging network; adjusting parameters of the residual attention network; training the content tagging network and keeping the parameters of the type tagging network unchanged; training the theme tagging network and keeping the parameters of the residual attention network, the parameters of the content tagging network, and the parameters of the type tagging network unchanged; adjusting the parameters of the type tagging network and keeping the parameters of the residual attention network, the parameters of content tagging network, and the parameters of theme tagging network unchanged. The training process can reduce a convergence time of the neural network and at the same time increase prediction accuracies of the neural network.

In another aspect, the present disclosure provides an apparatus for automatically tagging an input image using a neural network. In some embodiments, the apparatus includes a memory; one or more processors. Optionally, the memory and the one or more processors are connected with each other. Optionally, the memory stores computer-executable instructions for controlling the one or more processors to extract features of the input image and generate a first feature map including the features of the input image using a residual attention network; generate a predicted probability of a first tag of the input image based on the first feature map using a first tagging network; generate a predicted probability of a second tag of the input image based on the first feature map using a second tagging network; and generate a predicted probability of a third tag of the input image based on the first feature map using a third tagging network.

Various appropriate tags may be classified in different classifications. Examples of appropriate classifications include, but are not limited to, content tags, theme tags, type tags, tone tags, culture tags, and geographical position tags. Optionally, the first tagging network is a content tagging network, and the first tag is a content tag. Optionally, the second tagging network is a theme tagging network, and the second tag is a theme tag. Optionally, the third tagging network is a type tagging network, and the third tag is a type tag.

In some embodiments, the memory stores computer-executable instructions for controlling the one or more processors to set a first probability threshold for the content tag of the input image and a second probability threshold for the theme content tag of the input image; wherein the first probability threshold and the second probability threshold are different; the first probability threshold is obtained based on an optimal probability threshold of the content tag of the input image; and the second probability threshold is obtained based on an optimal probability threshold of the theme tag of the input image.

In some embodiments, the memory stores computer-executable instructions for controlling the one or more processors to set a plurality of probability thresholds for a tag of the input image; obtain a plurality of correct rates of the tag respectively using the plurality of probability thresholds; and set a probability threshold corresponding to a highest correct rate as the optimal probability threshold.

In some embodiments, prior to input the input image into the neural network, the memory stores computer-executable instructions for controlling the one or more processors to apply a data augmentation to the input image.

Optionally, the data augmentation includes a multi-crop method.

In some embodiments, the memory stores computer-executable instructions for controlling the one or more processors to pretrain the neural network. Optionally, pretraining the neural network includes training the residual attention network and the type tagging network using a training database of type tags; adjusting parameters of the residual attention network using a training database of content tags; training the content tagging network using the training database of content tags; training the theme tagging network using a training database of theme tags; adjusting parameters of the type tagging network using the training database of type tags.

Various appropriate memory may be used in the present virtual image display apparatus. Examples of appropriate memory include, but are not limited to, various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, magnetic disk or tape, optical storage media such as compact disk (CD) or DVD (digital versatile disk), and other non-transitory media. Optionally, the memory is a non-transitory memory. Various appropriate processors may be used in the present virtual image display apparatus. Examples of appropriate processors include, but are not limited to, a general-purpose processor, a central processing unit (CPU), a microprocessor, a digital signal processor (DSP), a controller, a microcontroller, a state machine, etc.

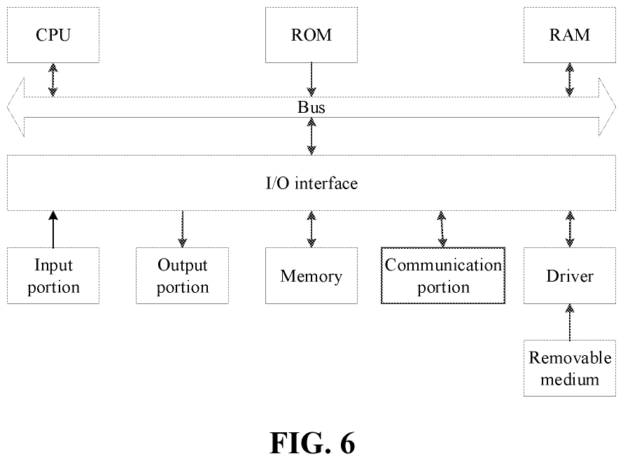

FIG. 6 is a schematic diagram of a structure of an apparatus for automatically tagging an input image in some embodiments according to the present disclosure. Referring to FIG. 6, in some embodiments, the apparatus includes the central processing unit (CPU) configured to perform actions according to the computer-executable instructions stored in a ROM or in a RAM. Optionally, data and programs required for a computer system are stored in RAM. Optionally, the CPU, the ROM, and the RAM are electrically connected to each other via bus. Optionally, an input/output interface is electrically connected to the bus.

In some embodiments, the apparatus includes an input portion connected to the I/O interface; an output portion electrically connected to the I/O interface; a memory electrically connected to the I/O interface; a communication portion electrically connected to the I/O interface; and a driver electrically connected to the I/O interface. Optionally, the input portion includes a keyboard, a mouse, etc. Optionally, the output portion includes a liquid crystal display panel, speaker, etc. Optionally, the communication portion includes network interface such as a LAN card, a modem, etc. Optionally, a removable medium such as a magnetic disk, an optical disk, a magneto-optical disk, a semiconductor memory is mounted on the driver as needed, so that the computer program in the removable medium can be installed.

In another aspect, the present disclosure also provides a non-transitory tangible computer-readable medium having computer-readable instructions thereon, the computer-readable instructions being executable by a processor to cause the processor to perform extracting features of the input image and generating a first feature map including the features of the input image using a residual attention network; generating a predicted probability of a first tag of the input image based on the first feature map using a first tagging network; generating a predicted probability of a second tag of the input image based on the first feature map using a second tagging network; and generating a predicted probability of a third tag of the input image based on the first feature map using a third tagging network.

Various appropriate tags may be classified in different classifications. Examples of appropriate classifications include, but are not limited to, content tags, theme tags, type tags, tone tags, culture tags, and geographical position tags. Optionally, the first tagging network is a content tagging network, and the first tag is a content tag. Optionally, the second tagging network is a theme tagging network, and the second tag is a theme tag. Optionally, the third tagging network is a type tagging network, and the third tag is a type tag.

In some embodiments, the computer-readable instructions being executable by a processor to cause the processor to perform setting a first probability threshold for the content tag of the input image and a second probability threshold for the theme content tag of the input image; wherein the first probability threshold and the second probability threshold are different; the first probability threshold is obtained based on an optimal probability threshold of the content tag of the input image; and the second probability threshold is obtained based on an optimal probability threshold of the theme tag of the input image.

In some embodiments, the computer-readable instructions being executable by a processor to cause the processor to perform setting a plurality of probability thresholds for a tag of the input image; obtaining a plurality of correct rates of the tag respectively using the plurality of probability thresholds; and setting a probability threshold corresponding to a highest correct rate as the optimal probability threshold.

In some embodiments, prior to input the input image into the neural network, the computer-readable instructions being executable by a processor to cause the processor to perform applying a data augmentation to the input image.

Optionally, the data augmentation includes a multi-crop method.

In some embodiments, the computer-readable instructions are executable by the processor to cause the processor to perform pretraining the neural network. Optionally, pretraining the neural network includes training the residual attention network and the type tagging network using a training database of type tags; adjusting parameters of the residual attention network using a training database of content tags; training the content tagging network using the training database of content tags; training the theme tagging network using a training database of theme tag; and adjusting parameters of the type tagging network using the training database of type tags.

Various illustrative neural networks, modules, layers, networks, nets, units, branches, classifiers, and other operations described in connection with the configurations disclosed herein may be implemented as electronic hardware, computer software, or combinations of both. Such neural networks, modules, layers, networks, nets, units, branches, classifiers, and other operations may be implemented or performed with a general purpose processor, a digital signal processor (DSP), an ASIC or ASSP, an FPGA or other programmable logic device, discrete gate or transistor logic, discrete hardware components, or any combination thereof designed to produce the configuration as disclosed herein. For example, such a configuration may be implemented at least in part as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a general purpose processor or other digital signal processing unit. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. A software module may reside in a non-transitory storage medium such as RAM (random-access memory), ROM (read-only memory), nonvolatile RAM (NVRAM) such as flash RAM, erasable programmable ROM (EPROM), electrically erasable programmable ROM (EEPROM), registers, hard disk, a removable disk, or a CD-ROM; or in any other form of storage medium known in the art. An illustrative storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A neural network for automatically tagging an input image, comprising:
a residual attention network configured to extract features of the input image and generate a first feature map comprising the features of the input image;
a first tagging network configured to receive the first feature map and generate a predicted probability of a first tag of the input image;
a second tagging network configured to receive the first feature map and generate a predicted probability of a second tag of the input image; and
a third tagging network configured to receive the first feature map and generate a predicted probability of a third tag of the input image.

2. The neural network of claim 1, further comprising a residual net (ResNet) configured to receive the first feature map and generate a second feature map having a scale smaller than a scale of the first feature map.

3. The neural network of claim 2, wherein the first tagging network comprises:
the residual net;
a spatial regularization network (SRN) configured to receive the first feature map and generate a first predicted probability of the first tag of the input image;
a first sub-network configured to receive the second feature map generated by the residual net and generate a second predicted probability of the first tag of the input image; and
the predicted probability of the first tag of the input image is an average value of the first predicted probability and the second predicted probability.

4. The neural network of claim 3, wherein the first feature map generated by the residual attention network is inputted, in parallel, into the spatial regularization network of the first tagging network and the residual net, respectively.

5. The neural network of claim 3, wherein the first sub-network comprises a first convolutional layer configured to receive the second feature map and generate a third feature map;
a first average pooling layer configured to receive the third feature map and generate a fourth feature map; and
a first fully connected layer configured to receive the fourth feature map and generate the second predicted probability of the first tag of the input image.

6. The neural network of claim 2, wherein the second tagging network comprises the residual net;
a first weighting module configured to generate a plurality of first weights respectively corresponding to a plurality of channels of the second feature map and apply a respective one of the plurality of first weights to a respective one of the plurality of channels of the second feature map generated by the residual net, thereby obtaining a fifth feature map;
a tagging correlation network comprising a plurality of convolutional sub-layers sequentially connected and configured to apply convolution processes on the fifth feature map, thereby obtaining a sixth feature map; and
a second fully connected layer configured to receive the sixth feature map and generate the predicted probability of the second tag of the input image.

7. The neural network of claim 2, wherein the third tagging network comprises the residual net;
a second weighting module configured to generate a plurality of second weights respectively corresponding to a plurality of channels of the second feature map and apply a respective one of the plurality of second weights to a respective one of the plurality of channels of the second feature map generated by the residual net, thereby obtaining a seventh feature map;
a second convolutional layer configured to receive the seventh feature map and generate an eighth feature map;
a second average pooling layer configured to receive the eighth feature map and generate a ninth feature map; and
a third fully connected layer configured to receive the ninth feature map and generate the predicted probability of the third tag of the input image.

8. The neural network of claim 2, wherein the first tagging network comprises the residual net; a spatial regularization network (SRN) configured to receive the first feature map and generate a first predicted probability of the first tag of the input image; and a first sub-network configured to receive the second feature map generated by the residual net and generate a second predicted probability of the first tag of the input image; and the predicted probability of the first tag of the input image is an average value of the first predicted probability and the second predicted probability;
the second tagging network comprises the residual net; a first weighting module configured to generate a plurality of first weights respectively corresponding to a plurality of channels of the second feature map and apply a respective one of the plurality of first weights to a respective one of the plurality of channels of the second feature map generated by the residual net to obtain a fifth feature map; a tagging correlation network comprising a plurality of convolutional sub-layers sequentially connected and configured to apply convolution processes on the fifth feature map to obtain a sixth feature map; and a second fully connected layer configured to receive the sixth feature map and generate the predicted probability of the second tag of the input image; and
the third tagging network comprises the residual net, a second weighting module configured to generate a plurality of second weights respectively corresponding to a plurality of channels of the second feature map and apply a respective one of the plurality of second weights to a respective one of the plurality of channels of the second feature map generated by the residual net to obtain a seventh feature map; a second convolutional layer configured to receive the seventh feature map and generate an eighth feature map; a second average pooling layer configured to receive the eighth feature map and generate a ninth feature map; and a third fully connected layer configured to receive the ninth feature map and generate the predicted probability of the third tag of the input image;
wherein the second feature map generated by the residual net is inputted, in parallel, into the first sub-network of the first tagging network, the first weighting module of the second tagging network, and the second weighting module of the third tagging network, respectively.

9. The neural network of claim 5, wherein the residual net comprises a first convolutional sub-layer, a second convolutional sub-layer, a third convolutional sub-layer;
the first convolutional sub-layer of the residual net has 512 number of kernels with a kernel size of 1*1;
the second convolutional sub-layer of the residual net has 512 number of kernels with a kernel size of 3*3;
the third convolutional sub-layer of the residual net has 2048 number of kernels with the kernel size of 1*1; and
the first feature map is successively processed by the first convolutional sub-layer of the residual net, the second convolutional sub-layer of the residual net, and the third convolutional sub-layer of the residual net, thereby obtaining the second feature map having a size of 7*7*2048;
wherein the first convolutional layer has 2048 number of kernels with the kernel size 3*3 and a stride of 2, configured to generate the third feature map having a size of 3*3*2048; and
the first average pooling layer has a first filter with a filter size of 3*3, configured to generate the fourth feature map having a size of 1*1*2048.

10. The neural network of claim 6, wherein the residual net comprises a first convolutional sub-layer, a second convolutional sub-layer, and a third convolutional sub-layer;
the first convolutional sub-layer of the residual net has 512 number of kernels with a kernel size of 1*1;
the second convolutional sub-layer of the residual net has 512 number of kernels with a kernel size of 3*3;
the third convolutional sub-layer of the residual net has 2048 number of kernels with the kernel size of 1*1; and
the first feature map is successively processed by the first convolutional sub-layer of the residual net, the second convolutional sub-layer of the residual net, and the third convolutional sub-layer of the residual net, thereby obtaining the second feature map having a size of 7*7*2048;
wherein the plurality of convolutional sub-layers of the tagging correlation network comprises a convolutional layer having K number of kernels with the kernel size of 1*1, a convolutional layer having 512 number of kernels with a kernel size of 1*1*K, 512 number of kernels with the kernel size of 1*1, and a convolutional layer having 512 groups of kernels, each of 512 groups of kernels has four kernels with a kernel size of 7*7, wherein K represents a total number of a plurality of second tags;
the plurality of convolutional sub-layers of the tagging correlation network are sequentially connected; and
the fifth feature map is successively processed by the plurality of convolutional sub-layers, thereby generating the sixth feature map.

11. The neural network of claim 7, wherein the residual net comprises a first convolutional sub-layer, a second convolutional sub-layer, and a third convolutional sub-layer;
the first convolutional sub-layer of the residual net has 512 number of kernels with a kernel size of 1*1;
the second convolutional sub-layer of the residual net has 512 number of kernels with a kernel size of 3*3;
the third convolutional sub-layer of the residual net has 2048 number of kernels with the kernel size of 1*1; and
the first feature map is successively processed by the first convolutional sub-layer of the residual net, the second convolutional sub-layer of the residual net, and the third convolutional sub-layer of the residual net, thereby obtaining the second feature map having a size of 7*7*2048;
wherein the second convolutional layer has 2048 number of kernels with the kernel size of 3*3 and a stride of 2;
the second average pooling layer has a second filter with a filter size of 3*3, configured to generate the ninth feature map having a size of 1*1*2048; and
the third fully connected layer is a Softmax layer.

12. A computer-implemented method for automatically tagging an input image using a neural network, comprising:
extracting features of the input image and generating a first feature map comprising the features of the input image using a residual attention network;
generating a predicted probability of a first tag of the input image based on the first feature map using a first tagging network;
generating a predicted probability of a second tag of the input image based on the first feature map using a second tagging network; and
generating a predicted probability of a third tag of the input image based on the first feature map using a third tagging network.

13. The computer-implemented method of claim 12, further comprising setting a first probability threshold for the first tag of the input image and a second probability threshold for the second tag of the input image;
wherein the first probability threshold and the second probability threshold are different;
the first probability threshold is obtained based on an optimal probability threshold of the first tag of the input image; and
the second probability threshold is obtained based on an optimal probability threshold of the second tag of the input image.

14. The computer-implemented method of claim 13, further comprising setting a plurality of probability thresholds for the first tag of the input image;
setting a plurality of probability thresholds for the second tag of the input image;
obtaining a plurality of correct rates of the first tag respectively using the plurality of probability thresholds for the first tag of the input image;
obtaining a plurality of correct rates of the second tag respectively using the plurality of the probability thresholds for the second tag of the input image;
setting one of the plurality of probability thresholds for the first tag corresponding to a highest correct rate of the plurality of correct rates of the first tag as the optimal probability threshold of the first tag of the input image; and
setting one of the plurality of probability thresholds for the second tag corresponding to a highest correct rate of the plurality of correct rates of the second tag as optimal probability threshold of the second tag of the input image.

15. The computer-implemented method of claim 12, prior to input the input image into the neural network, comprising applying a data augmentation to the input image.

16. The computer-implemented method of claim 15, wherein
the data augmentation comprises a multi-crop method.

17. The computer-implemented method of claim 12, further comprising pretraining the neural network;
wherein pretraining the neural network comprises:
training the residual attention network and the third tagging network using a training database of third tags;
adjusting parameters of the residual attention network using a training database of first tags;
training the first tagging network using the training database of first tags;
training the second tagging network using a training database of second tags; and
adjusting parameters of the third tagging network using the training database of third tags.

18. An apparatus for automatically tagging an input image using a neural network of claim 1, comprising:
a memory;
one or more processors;
wherein the memory and the one or more processors are connected with each other; and
the memory stores computer-executable instructions for controlling the one or more processors to:
extract features of the input image and generate a first feature map comprising the features of the input image using a residual attention network;
generate a predicted probability of a first tag of the input image based on the first feature map using a first tagging network;
generate a predicted probability of a second tag of the input image based on the first feature map using a second tagging network; and
generate a predicted probability of a third tag of the input image based on the first feature map using a third tagging network.

19. The apparatus of claim 18, wherein the memory stores computer-executable instructions for controlling the one or more processors to pretrain the neural network;
wherein pretraining the neural network comprises:
training the residual attention network and the third tagging network using a training database of third tags;
adjusting parameters of the residual attention network using a training database of first tags;
training the first tagging network using the training database of first tags;
training the second tagging network using a training database of second tags; and
adjusting parameters of the third tagging network using the training database of third tags.

20. A computer-program product comprising a non-transitory tangible computer-readable medium having computer-readable instructions thereon, the computer-readable instructions being executable by a processor to cause the processor to perform:
extracting features of an input image and generating a first feature map comprising the features of the input image using a residual attention network;
generating a predicted probability of a first tag of the input image based on the first feature map using a first tagging network;
generating a predicted probability of a second tag of the input image based on the first feature map using a second tagging network; and
generating a predicted probability of a third tag of the input image based on the first feature map using a third tagging network.

21. (canceled)
